(19) United States
(12) Patent Application Publication
(10) Pub. No.: US 2009/0087817 A1
(43) Pub. Date: Apr. 2, 2009

(54) Method for producing a crown for an implant abutment

(75) Inventors: Curtis E. Jansen, Pacific Grove, CA (US); Henley S. Quadling, Dallas, TX (US); Mark S. Quadling, Plano, TX (US); Gary L. Severance, Dallas, TX (US)

Correspondence Address: J. Andrew Lowes;Haynes and Boone, LLP, Suite 700, 2323 Victory Ave., Dallas, TX, 75219, US

(73) Assignee: D4D Technologies, LLC, Richardson, TX (US)

(21) Appl. No.: 12/239,262

(22) Filed: Sep. 26, 2008

Related U.S. Application Data
(60) Provisional application No. 60/975,333, filed on Sep. 26, 2007.

(51) Int. Cl. A61C 5/10

(52) U.S. Cl. 433/223

(57) ABSTRACT

A method of producing a crown for a custom implant abutment is carried out as follows. The method begins by preparing a patient's existing dental structures, viz., positioning a dental implant in the patient's mouth. Using a scanner device and associated modeling software, a first 3D model is obtained of a sufficiently large portion of an implant abutment to be attached to the implant. This scan is performed extra-orally. Preferably, the sufficiently large portion is that portion of the abutment bounded by a margin curve. After the implant abutment is attached to the implant (intra-orally), the scanner is used to obtain a second 3D model of the implant abutment attached to the implant (i.e., an intra-oral scan). Using the modeling software, the first 3D model is then aligned to the second 3D model. Thereafter, a boundary curve on the first 3D model is identified. Using the boundary curve to trim the first 3D model, the system then produces a third 3D model. Using the boundary curve, the third 3D model and the second 3D model, the system then creates a fourth 3D model, which is a model of a virtual dental item. Using a computer-assisted milling machine, the model of the virtual dental item is then used to produce an actual crown, which is then attached to the implant to complete the process.

This application is based on and claims priority to Ser. No. 60/975,333, filed Sep. 26, 2007.

### BACKGROUND OF THE INVENTION

1. Technical Field

The present invention relates to computer-assisted techniques for creating dental restorations or appliances.

2. Brief Description of the Related Art

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for a restoration by removing existing anatomy, which is then lost. The resultant prepared area (a “preparation”) is then digitized (or, in the alternative, a dental impression is taken) for the purpose of constructing a restoration, appliance or substructure. The restoration itself may be constructed through a variety of techniques including manually constructing the restoration, using automated techniques based on computer algorithms, or a combination of manual and automated techniques.

Computer-assisted techniques have been developed to generate three-dimensional (“3D”) visual images of physical objects, such as a dental preparation. In general, the 3D image may be generated by a computer that processes data representing the surfaces and contours of a physical object. The computer displays the 3D image on a screen or a computer monitor. The computer typically includes a graphical user interface (GUI). Data is generated by optically scanning the physical object and detecting or capturing the light reflected off of the object. Based on processing techniques, the shape, surfaces and/or contours of the object may be modeled by the computer.

During the process of creating a tooth restoration model, one or more user interface tools may be provided to facilitate the design process. One known display technique uses a computer monitor that, under software control, displays a 3-dimensional representation of a tooth model.

### BRIEF SUMMARY

According to an embodiment, a method of producing a crown for an implant abutment is carried out as follows. The method begins by preparing a patient's existing dental structures, viz., positioning a dental implant in the patient's mouth. Using a scanner device and associated modeling software, a first 3D model is obtained of a sufficiently large portion of an implant abutment to be attached to the implant. This scan is performed extra-orally. Preferably, the sufficiently large portion is that portion of the abutment bounded by a margin curve. After the implant abutment is attached to the implant (intra-orally), the scanner is used to obtain a second 3D model of the implant abutment attached to the implant (i.e., an intra-oral scan). Using the modeling software, the first 3D model is then aligned to the second 3D model. Thereafter, a boundary curve on the first 3D model is identified. Using the boundary curve to trim the first 3D model, the system then produces a third 3D model. Using the boundary curve, the third 3D model and the second 3D model, the system then creates a fourth 3D model, which is a model of a virtual dental item. Using a computer-assisted milling machine, the model of the virtual dental item is then used to produce an actual crown, which is then attached to the implant to complete the process.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The subject matter herein may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a computer system in which the method described herein may be implemented;

FIG. 2 illustrates an abutment model (the “first model”) showing a margin curve;

FIG. 3 illustrates a “second” model, which captures the locations of neighbor dentition relative to the final placement of the abutment;

FIG. 4 illustrates a “third” model, which is generated by positioning the first model virtually using software so that the portion of the abutment visible in the second model overlaps with the first model with the equivalent areas brought into coincidence;

FIG. 5 illustrates a “fourth model” of a virtual dental item that is generated using the third model and other information; and

FIG. 6 illustrates workstation display interface showing a tooth crown on top of the merged abutment model/preparation model.

### DETAILED DESCRIPTION

The subject matter of this disclosure is implemented in a system that is used to design restorative models for permanent (or semi-permanent, or removable) placement in a patient's mouth.

According to one aspect, the techniques described herein are useful to produce a crown to be placed on a custom implant abutment. Because the implant abutment is custom designed (i.e., to fit the implant), the interior of the crown that attaches to the abutment also needs to be custom designed for the particular case. The usual process followed is for an implant to be inserted into the jawbone (or maxillary-upper arch) of a patient. An abutment (made, for example, from titanium or zirconia) is then screwed (or placed or cemented) onto the top of the implant and is then adjusted by the dentist using dental tools. The abutment is in a sense adjusted in the same way a tooth stump is prepared for a typical crown procedure and can be considered to be an artificial prep. (Of course, there may be cases where no adjustment by the dentist is needed). At this point, the abutment may be digitized by a 3D scanner (such as the D4D intraoral digitizer), and a crown model generated using CAD techniques, and finally a physical crown (or appliance) milled out of a dental material such as ceramic, composite or metal. In the case of an implant, however, it may be advantageous to wait for a significant period of time before placing a final restoration. For example, it may be advantageous to allow the jawbone (maxillary or mandibular) sufficient time to regenerate and form a more permanent bond to the implant. In such case, however, the gums may grow over or above the margin of the abutment, thus obscuring them, and a 3D scanner would not be able to adequately scan the abutment fully.

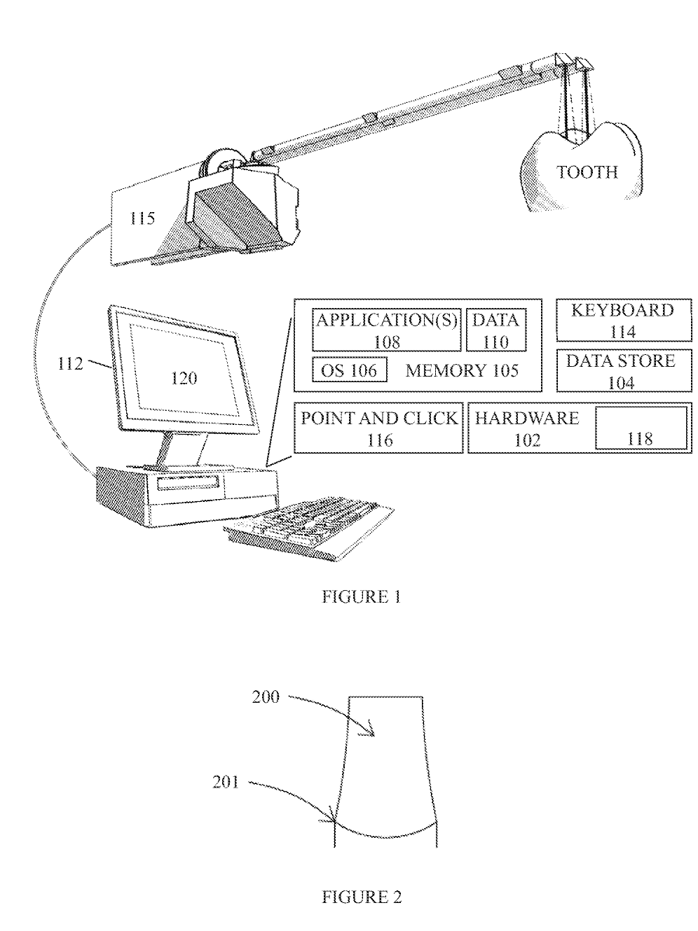

According to this disclosure, the abutment is scanned at the time it is customized (placed), i.e., at the time that the implant is first inserted. When customization of the implant is completed, either the abutment is removed for scanning outside the mouth, or the abutment is scanned inside the mouth while attached to the implant. A desired goal here is to be able to see the entire surface (or substantially the entire surface) of the abutment that will form the interior interface to the crown. In particular, preferably the margin edge is fully visible so that it is captured by the scanning process. Referring to FIG. 2, the abutment is labeled by 200 and the margin curve 201 is fully visible. The computer model of the abutment thus obtained is then set aside until the patient returns at some period in the future, and this model is referred to hereinafter as the first model. If the abutment is scanned while placed on the implant, it is desirable that the scanning technique not require the use of a scanning agent or aid, such as powder or liquid, because these aids should not be applied to an active surgical site.

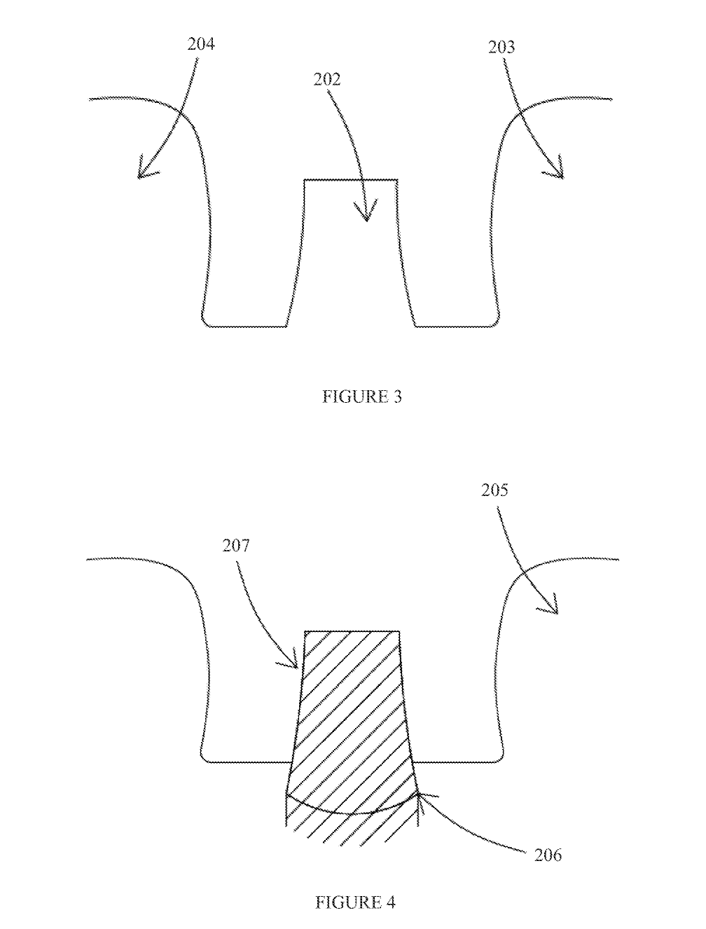

When the patient returns later for the final placement of the crown, the site is scanned again. By this time, it is expected that the tissue around the implant and abutment site has regenerated, and the tissue may partially obscure the abutment. Referring to FIG. 3, it is likely that only a portion of the abutment (labeled as 202) is visible above the tissue. This model is important however, as it captures the locations of the neighbors 203 and 204 relative to the final placement of the abutment. The new scanned model thus obtained is referred to hereinafter as the second model.

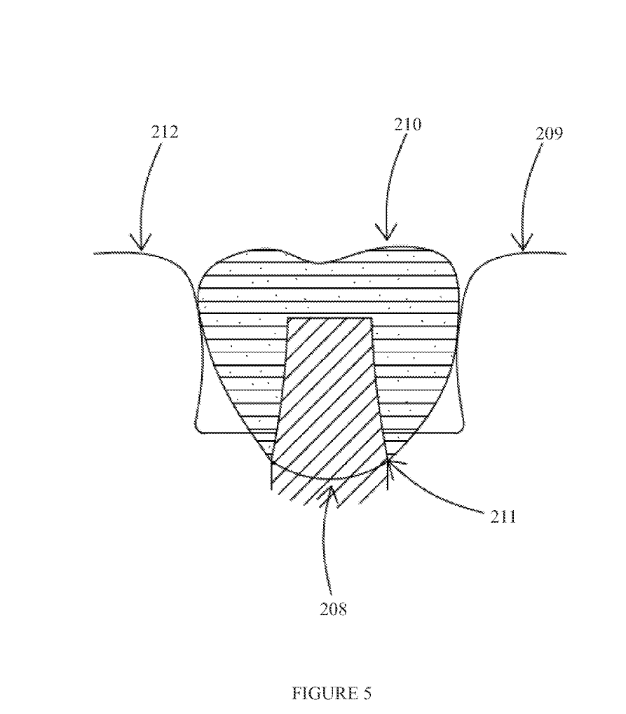

Referring to FIG. 4, the first model is then positioned virtually using software so that the portion of the abutment visible in the second model overlaps with the first model with the equivalent areas brought into coincidence. In this drawing, reference numeral 206 represents the first model, and reference numeral 205 represents the second model. The overlap area where the two models agree is labeled as 207. This optimal alignment may be done either manually or automatically using well known alignment methods (such as ICP or the Iterative Closest Pair alignment method). As can be noted in the figure, portions of the abutment model 206 may lie below the preparation model because tissue may have grown over the lower portion of the abutment.

Once the two data sets have been merged, a restoration (referred to herein as the fourth model) may be created using well- known methods. For example, and as demonstrated in FIG. 5, a margin curve 211 may be identified on the first model 208. A restoration 210 may then be generated on top of the abutment by choosing a surface form and ensuring that it fits precisely between the neighboring teeth 209 and 212 and has the required form. The restoration generated in this way attaches to the margin of the abutment, and the interior surface of the crown is also obtained from the surface of the abutment model. As can be noted, the restoration model attaches to the abutment model that forms its lower surface, while also maintaining the correct contact with the proximal teeth as captured in the preparation model.

Once designed, the virtual 3D model of the restoration may then be milled out using well-known methods to generate a tool path and to produce the restoration using a milling machine, such as described in U.S. Pat. No. 7,270,592, the disclosure of which is incorporated by reference. Alternatively, the restoration may be generated using a rapid prototyping system, such as described in U.S. Publication No. 20070218426, the disclosure of which is incorporated by reference. The physical restoration (in this example a crown) may then be placed onto the abutment and cemented in place. This can all happen in a single return visit by the patient (the first visit was when the implant was placed. While the above steps are typical, the crown (whether provisional or final) may even be placed during a first office appointment, and thus it is not necessary that the patient come back for a second visit.

Of course, while the above-described steps are illustrative, there is no specified or required time period between obtaining the first digitized model and the second digitized model. In other words, any desired time period between the two described operations may be used.

Moreover, while a particular embodiment has been described, the method may be applied to other more general cases where the final item to be placed into the mouth comprises any two portions, where the first portion is digitized at a different time to the second portion. Thus, in an alternative embodiment, a first dental item is an implant (as opposed to an implant abutment), a sufficiently large portion of which protrudes above a bone, and the second dental item is an abutment (instead of a crown that is attached to the implant abutment). In this embodiment, the crown (a third dental item) is fitted to the abutment.

The described technique of taking information/positioning from the patient's mouth (or from a model of the patient's mouth) and merging that data with similar information from out of the mouth (a model/jig) is advantageous. The dentist or other specialist is not required to use powder or to spray anything onto the site. Thus, scanning is carried out without a scanning aid or other opaque agent. The software automatically merges the data (margins) from the model (or identified manually) with data associated with a specific position in the mouth; as a consequence, the implant site and implant abutment can be aligned virtually and the final restoration milled to take into account the margins (from the model) and the position (from the mouth).

The above-described process is not restricted to implants but may be used for other purposes, such as a provisional service, e.g., scanning a wax up on a model and transferring that information to a mouth scan to achieve a merged virtual model from various source images.

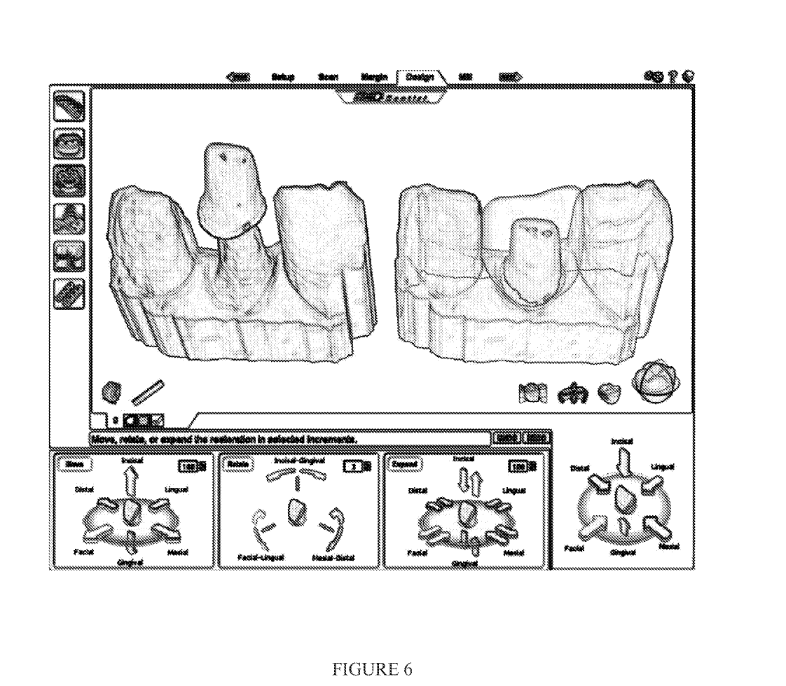

Several of the processing steps are performed in a computer. As seen in FIG. 1, a representative computer 100 comprises hardware 102, suitable storage 104 and memory 105 for storing an operating system 106, one or more software applications 108 and data 110, conventional input and output devices (a display 112, a keyboard 114, a point-and-click device 116, and the like), other devices 118 to provide network connectivity, and the like. A laser digitizer system 115 is used to obtain optical scans from a patient's dental anatomy. Using a conventional graphical user interface 120, an operator can view and manipulate models as they are rendered on the display 112. FIG. 6 illustrates this functionality.

An intra-oral scan may be obtained using an intra-oral digitizer, such as the E4D Dentist system available from D4D Technologies, LLC and described by commonly-owned, U.S. Pat. No. 7,184,150, the disclosure of which is incorporated by reference. The prepared area and adjacent teeth are scanned using the digitizer, and a 3D model of the prepared area is obtained. This information may then be used to produce a 3D model of a desired restoration. Such a process can be performed using the Design Center available as part of the E4D Dentist system from D4D Technologies, LP, Richardson, Tex.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic. Further, while given components of the system have been described separately, one of ordinary skill will appreciate that some of the functions may be combined or shared in given systems, machines, devices, processes, instructions, program sequences, code portions, and the like.

Having described our invention, what we now claim is as follows.

1. A method of creating a dental restoration for a patient's existing dental structure, comprising:
(a) obtaining a first 3D model of at least a portion of a first dental item;
(b) attaching the first dental item to the patient's existing dental structure;
(c) obtaining a second 3D model of the first dental item while attached to the patient's existing dental structure;
(d) aligning the first 3D model to the second 3D model;
(e) identifying a boundary curve on the first 3D model, and producing a third 3D model by using the boundary curve to trim the first 3D model;
(f) producing a fourth 3D model of a virtual dental item using the boundary curve, the third 3D model and the second 3D model;
(g) producing a second dental item from the fourth 3D model; and
(h) attaching the second dental item to the first dental item.

2. The method of claim 1 where the first dental item is an implant abutment attached to an implant, where the portion comprises that portion of the abutment bounded by a margin curve.

3. The method of claim 2 where the second dental item is a crown.

4. The method of claim 1 where the production of the second dental item is obtained by a CAD/CAM milling machine.

5. The method of claim 1 where the production of the second dental item is obtained through rapid prototyping.

6. The method of claim 1 where the 3D digitized models are obtained using a scanning method without a scanning aid or an opaque agent used to facilitate scanning.

7. The method of claim 1 where the first dental item is an implant, where the portion comprises that portion of the implant protruding above a bone.

8. The method of claim 7 where the second dental item is an abutment.

9. The method of claim 8 further including fitting a third dental item to the second dental item.

10. The method as described in claim 9 wherein the third dental item is a crown.
